(19) United States
(12) Patent Application Publication
(10) Pub. No.: US 2011/0202462 A1
(43) Pub. Date: Aug. 18, 2011

(54) METHOD FOR A PAYMENT CARDHOLDER TO CONTROL AND MANAGE THE USE OF A PAYMENT CARD

(75) Inventor: Rob A. Keenan, London (GB)

(73) Assignee: MASTERCARD INTERNATIONAL INC., Purchase, NY (US)

(21) Appl. No.: 13/062,403

(22) PCT Filed: Sep. 8, 2009
(86) PCT No.: PCT/US09/05029

§ 371 Date: May 3, 2011

Related U.S. Application Data
(62) Division of application No. 61/095,125, filed on Sep. 8, 2008.

(51) Int. Cl. G06Q 20/00; G06Q 40/00

(52) U.S. Cl. 705/44

(57) ABSTRACT

A method for providing a payment cardholder with control over a payment card is provided herein, hi one respect, the method of the present invention uses a managing platform to configure a set of usage parameters for usage of the payment card. After that, the payment card is associated with the managing platform, and allows the payment cardholder to select one or more of the usage parameters. Based on the selected usage parameters, a set of cardholder parameters are associated with the payment card, and include defining rules for determining an acceptable transaction and an unacceptable transaction for the payment card. Then, the managing platform intercepts an authorization for each transaction of the payment card and identifies, based on the cardholder parameters, each of the transactions as being one of the acceptable transactions or the unacceptable transactions. Finally, a message notifies the payment cardholder of at least one of the unacceptable transactions.

### INCORPORATION OF PRIOR PATENTS AND PATENT

Applicants incorporate herein by reference for all purposes each of U.S. Non-Provisional application Ser. No. 12/544,009 filed Aug. 19, 2009, Provisional Application No. 60/935,187 filed Jul. 30, 2007, U.S. Non-Provisional application Ser. No. 10/160,178 filed Jun. 4, 2002, Non-Provisional application Ser. No. 09/506,830 filed Jan. 18, 2000; U.S. Non-Provisional application Ser. No. 09/235,836 filed Jan. 22, 1999 and now U.S. Pat. No. 6,636,833; U.S. Provisional Application No. 60/935,187 filed Jul. 30, 2007; U.S. Provisional Application No. 60/295,020 filed Jun. 4, 2001; U.S. Provisional Application No. 60/120,747 filed Feb. 18, 1999; U.S. Provisional Application No. 60/134,027 filed May 13, 1999; U.S. Provisional Application No. 60/144,875 filed Jul. 20, 1999; U.S. Provisional Application No. 60/147,153 filed Aug. 4, 1999; U.S. Provisional Application No. 60/099,614 filed Sep. 9, 1998; U.S. Provisional Application No. 60/098,175 filed Aug. 26, 1998; U.S. Provisional Application No. 60/092,500 filed Jul. 13, 1998; Irish Application No. S98 0458 filed Jun. 15, 1998; Irish Application No. S98 0346 filed May 5, 1998; Irish Application No. S98 0223, filed Mar. 25, 1998.

### BACKGROUND OF THE INVENTION

1. Field of the Invention

The present invention generally relates to a method for payment cardholders to control and manage a payment card through usage parameters. More specifically, the method provides payment cardholders with the ability to select usage parameters and define rules for the usage parameters that allow the cardholder to manage and safeguard the payment card by providing messages and declining transactions based on the occurrence of predefined usage parameters and providing analysis of the payment cardholder's transactions.

2. Brief Description of the Related Art

Currently, payment cards are a convenient and secure method of making payments, but there are still risks with payment card usage, especially in remote locations. As a result, some payment cardholders doubt the value of using payment cards because of the inability to eliminate all risks. The payment cardholder's reaction to the perceived risks and insecurities of payment card usage results in diminished confidence and faith in financial institutions because the financial institution's response to fraud risks sometimes does not clearly demonstrate to payment cardholders that the financial institution is actively battling fraud. Without confidence in financial institutions, some payment cardholders decide to use cash for purchases they consider “risky” thereby causing a reduction in transaction volumes of payment cards.

In addition, some payment cardholders are reluctant to use a payment card due to a feeling of loss of control of spending. When cash is used a party is able to at least monitor money being spent and establish how much is spent by determining the amount left in the party's wallet. The problem with cash is that it is more difficult to keep track of total amounts spent over a period of time and requires manual calculations by the party. For example, if a party wants to determine how much money was spent during a particular day, at a particular merchant, or on a particular type of goods over a time period, such as a week, the party must manually use receipts to calculate totals for each of the above individually to analyze spending patterns.

Therefore, it would be advantageous to provide a cardholder with the ability to control and manage spending and the usage of the payment card, by providing the payment cardholder with greater confidence when using the payment card and encouraging the payment cardholder to use the payment card for all transaction.

### SUMMARY OF THE INVENTION

A method for providing a payment cardholder with control over a payment card and manage spending using the payment card is provided herein.

A first method for providing a payment cardholder with control over a payment card uses a managing platform to configure a set of usage parameters for usage of the payment card. After that, the payment card is associated with the managing platform, and allows the payment cardholder to select one or more of the usage parameters. Based on the selected usage parameters, the cardholder defines rules for each usage parameter and such set of cardholder parameters are associated with the payment card. The cardholder-defined rules determine an acceptable transaction and an unacceptable transaction for the payment card. Then, the managing platform intercepts an authorization for each transaction of the payment card and identifies, based on the cardholder parameters, each of the transactions as being one of the acceptable transactions or the unacceptable transactions. Finally, a message notifies the payment cardholder of at least one of the unacceptable transactions, if any.

A second method for providing a payment cardholder with control over a payment card uses a managing platform to configure a set of usage parameters for usage of the payment card. After that, the payment card is associated with the managing platform, and allows the payment cardholder to select one or more of the usage parameters. Based on the selected usage parameters, a set of cardholder parameters are associated with the payment card, and include defining rules for determining an acceptable transaction and an unacceptable transaction for the payment card. Then, the managing platform intercepts an authorization for each transaction of the payment card and identifies, based on the cardholder parameters, each of the transactions as being one of the acceptable transactions or the unacceptable transactions. Finally, the managing platform declines at least one of the authorizations for the transactions identified by the cardholder parameters as one of the unacceptable transactions.

A third method for providing a payment cardholder with the ability to manage a payment card using a managing platform to configure a set of usage parameters for usage of the payment card. After that, the payment card is associated with the managing platform, and allows the payment cardholder to select one or more of the usage parameters. Based on the selected usage parameters, a set of cardholder parameters are associated with the payment card, and include defining rules for determining an acceptable transaction and an unacceptable transaction for the payment card, defined by a budget. Then, the managing platform intercepts each transaction of the payment card and identifies, based on the cardholder parameters, each of the transactions as being one of the acceptable transactions or the unacceptable transactions. Finally, the managing platform displays information on a set of selected transaction based on a set of all transactions for the payment card, using a user interface.

Other objects and features of the present invention will become apparent from the following detailed description considered in conjunction with the accompanying drawing. It is to be understood, however, that the drawing is designed as an illustration only and not as a definition of the limits of the invention.

### BRIEF DESCRIPTION OF THE DRAWINGS

FIG. 1 is a pictorial diagram of an exemplary embodiment of the present invention using a managing platform to prevent undesired usage of a payment card.

FIG. 2 is a pictorial diagram of an exemplary embodiment of the present invention using a managing platform to monitor spending through a payment card.

FIGS. 3-14 are computer screenshots from a user interface that provides a payment cardholder with the ability to control and manage spending on a payment card.

### DETAILED DESCRIPTION OF THE PREFERRED EMBODIMENTS

The present invention provides a payment cardholder with additional reassurances and gives the payment cardholder extra peace of mind by allowing the payment cardholder to use a card protection plan with existing payment cards that provides protection from fraud or misuse, and allows the cardholder to use the payment card to manage and monitor spending habits. The present invention also provides protection and control by enabling a financial institution or payment card issuer to configure a set of usage parameters, adaptable to the payment cardholder's typical spending activities. The payment cards eligible for use with this invention include, but are not limited to, debit cards and credit cards.

The present invention further provides the payment cardholder with the ability to select a set of cardholder parameters based on the usage parameters and associate the cardholder parameters with the payment card. The cardholder parameters include, for example, defining rules for determining transactions that are acceptable and unacceptable for the payment card. An acceptable transaction may include transactions that the cardholder does not identify as requiring the receipt of a message from the managing platform or a transaction that is not blocked by the managing platform. An unacceptable transaction may include transactions that a cardholder defines as being outside usual habits or spending patterns, being outside a budget, exceeding usage limits, or triggering as a reminder or notification of one or more specific transactions occurring.

The selection of acceptable and unacceptable transactions may include selection from predefined options or blank fields for each of the usage parameters that allow the payment cardholder to define details, such as specific dollar or transaction limitations. The cardholder parameters then may be used to provide payment cardholders with more control over their spending by enabling the cardholder to use the payment card to set budgets and assist the payment cardholder in keeping track of spending.

The present invention provides the payment cardholder with control over and management of the payment card using a managing platform, such as the service provided under the trademark “MasterCard in Control” registered to MasterCard International, Inc. The managing platform may offer various features including an array of advanced authorization, transaction routing, and alert controls designed to enable payment card issuers to more quickly and cost-efficiently introduce new and enhanced products. More specifically, the managing platform allows a payment card issuer to efficiently customize payment card parameters, including usage parameters, based on specific consumer or corporate payment cardholder needs. The managing platform may be managed by the payment card issuer or another vendor or financial institution.

The managing platform may reside on one or more central processing units, which are networked and accessible through any known technique or interface. The user interface of the managing platform is accessible by the payment card holder, the managing platform, and the payment card issuer. The user interface may include multiple interfaces on multiple computers, and is capable of being accessed by one or more persons. The present invention contemplates the use of any managing platform that fulfills the functionality described herein.

In particular, the managing platform uses the set of usage parameters provided thereto, such as by a vendor, a financial institution, or the payment card issuer, to allow the payment cardholder to configure the set of cardholder parameters by selecting one or more usage parameters and defining rules for the usage parameters selected. The cardholder parameters may designate transactions as acceptable and unacceptable, and may allow the cardholder to specify threshold values for maximums or limitations on transactions. When unacceptable activity occurs, the managing platform may be configured to send the cardholder a message or decline transactions or patterns of transactions that are unacceptable, according to the cardholder parameters. The managing platform may also be configured to analyze transactions and display an analysis of the transactions associated with the payment based on cardholder parameters.

Examples of the set of usage parameters, which may be used to define a set of cardholder parameters using a managing platform include, but are not limited to, a limit on aggregate transaction amounts over a specified time period, such as a day, a week, a month, or a weekend; a limit on the amount of a single transaction, such as a limit of $500 per transaction applied to all payment card associated with the managing platform or a limit of $500 per transaction only applied to ATM, Merchant Classification Code (MCC), Mail Order/Telephone Order (MOTO), and/or E-Commerce transactions; a maximum number of transactions in a specific time period, such as a day, a week, a month, or a weekend; a maximum number of transactions for specific types of transactions, such as E-commerce, MOTO, ATMs, MCC, a group of MCCs; a maximum number of each specific type of transactions, e.g., E-commerce and MOTO; a limit on the geographic use of the card, e.g., allow use only in United States or block use in Greece and Italy; a block on specific types of transactions, such as blocking E-commerce, MOTO, MCC, group of MCCs, and/or ATM transactions; a limit on the geographic use of the payment card based on the type of transaction, e.g., block non-domestic ATM transactions; a limit on the days of the week when a payment card may be used, such as the payment card may only be used Monday through Friday; and/or, a limit on the time of the day when a payment card may be used, e.g., block use between the hours of 2 AM and 5 AM.

The managing platform may further be configured to send a message to the payment card holder using Short Message Service (SMS), Instant Messaging (IM), e-mail, or other real-time and near real-time channels for all or selected transactions. The managing platform may also provide the payment cardholder with the ability to designate different types of messages depending on each specific unacceptable transaction. For example, if the unacceptable transaction is considered high importance, the payment cardholder may want the message for immediate transmission, such as by using SMS. Conversely, if the unacceptable transaction is considered low importance, the payment cardholder may designate e-mail notification. Unacceptable transactions may also be blocked using the managing platform.

The managing platform may be configured such that, after the transaction occurs, the payment cardholder may use the managing platform to review all transactions associated with the payment card. The managing platform optionally monitors and manages transactions made using the payment card such that the payment cardholder may have access to the following information about the spending associated with the payment card: (1) individual transaction details; (2) previous transaction information; (3) information about multiple payment cards; (4) a comparison of payment-cardholder-inputted budget information and actual spending; (5) spending statements; (6) a graphic analysis of spending; (7) analysis of the transaction type, such as the location of transaction and the cardholder who initiated transaction; and/or, (8) comparison of payment cardholder's spending against national average data, depending on availability.

In addition, insurances may be built into the managing platform to provide zero liability and protection from identity theft, such that the payment cardholder is not liable for any unauthorized or fraudulent usage, whatever the circumstances. The payment card is associated with the managing platform using any known technique and can be associated by the payment card issuer, the payment cardholder, the manger of the managing platform, and/or by a further third party.

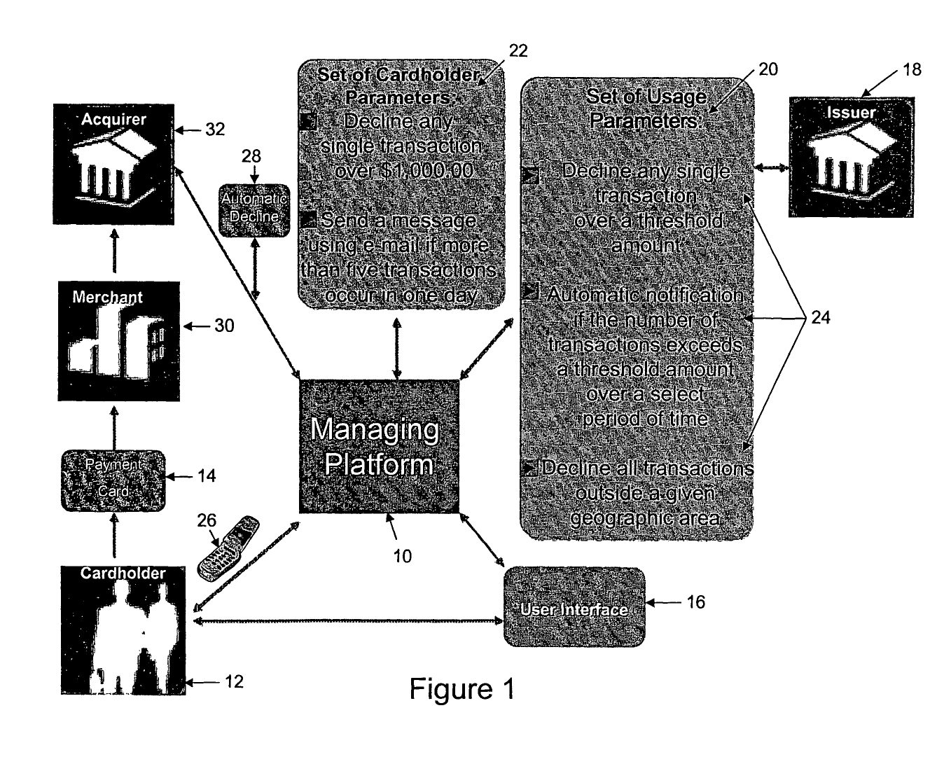

With reference to FIG. 1, an example of the present invention is shown using a managing platform 10 to allow a payment cardholder 12 to control a payment card 14 using a user interface 16 by preventing undesired usage of the payment card 14 and monitoring usage of the payment card 14.

First, the managing platform 10 enables a party, e.g., a payment card issuer 18, to establish a set of usage parameters 20. For exemplary purposes, and by way of nonlimiting example, the set of usage parameters 20 may be configured by the payment card issuer 18 to include (1) decline any single transaction over a threshold amount; (2) automatic notification if the number of transactions exceeds a threshold amount over a select period of time; (3) decline all transactions outside a given geographic area (stated differently, authorize only transaction from a given geographic area). Then, the payment cardholder 12 may access the managing platform 10 using the user interface 16. The user interface 16 enables the payment cardholder 12 to access the managing platform 10, and the payment cardholder 12 may define a set of cardholder parameters 22 based a selection of on the usage parameters 20. This selection may include the user providing specific variables for the usage parameters 20 in defining cardholder parameters 22.

Thus, for example, and with reference to the usage parameters 20 noted above, the cardholder parameters 22 may be defined to: (1) decline any single transaction over $1,000.00; (2) send a message using e-mail if more than five transactions occur in one day; and (3) allow transactions only in Spain, Italy, and England.

It is important to note that the payment cardholder's 12 selection of the set of cardholder parameters 22 may include any combination of usage parameters 20, such that the payment cardholder 12 may select all the usage parameters 20, only one of the usage parameters 20 or any number of usage parameters 20. Additionally, the payment cardholder 12 may make changes to the selected cardholder parameters 22 at any time using the user interface 16. From the cardholder parameters 22, the payment cardholder 12 may define rules for determining acceptable and unacceptable transactions. In particular, the cardholder parameters 22 may be defined to include amounts and/or other characteristics, which define thresholds for evaluating whether a transaction is acceptable (i.e., falls within a desired range of usage) or unacceptable (i.e., falls outside a desired range of usage). The payment cardholder 12 also may select as the cardholder parameters 22 whether (1) a message 26 is provided to the payment cardholder 12; (2) the transaction is declined (e.g., an unacceptable transaction) using an automatic decline feature 28; or (3) both the message 26 is sent to the payment cardholder 12 and the transaction is declined by the automatic decline feature 28. The automatic decline feature 28 is optional and not required.

Once determined, the cardholder parameters 22 are associated with the payment card 14. For example, the managing platform 10 stores the cardholder parameters 22 and associates the stored cardholder parameters 22 with the payment card 14 using identifying information, e.g., the managing platform 10 assigns a unique identification number to the payment card 14 and uses the unique identification number to associate the stored cardholder parameters 22 with the payment card 14. The payment cardholder 12 may use the system with two or more of the payment cards 14, with the cardholder parameters 22 being selected once for some or all of the payment cards 14 or the cardholder parameters 22 may be tailored to some or all of the payment cards 14. Then, each set of the cardholder parameters 22 is associated with the related payment card 14.

After associating the cardholder parameters 22 with the payment card 14, the payment cardholder 12 may use the payment card 14 in the usual manner. When the payment card 14 is used, the merchant 30 initiates the transaction by sending the payment card 14 information to an acquirer 32. After the transaction leaves the acquirer 32, the managing platform 10 intercepts the authorization of the transaction. The managing platform 10 uses the payment cardholder's 12 set of cardholder parameters 22 to determine if any action is necessary (e.g., based on the cardholder parameters 22), such as sending the message 26 to the payment cardholder 12 or declining authorization for the transaction using the automatic decline feature 28 (e.g., if a transaction is determined to be unacceptable) in the managing platform 10. The managing platform 10 may be configured to send the message 26 and/or activate the automatic decline feature for transactions found to be unacceptable. It is important to note, when the message 26 is sent to the payment cardholder 12, the transaction authorization remains uninterrupted. The transaction authorization is interrupted where the automatic decline feature 28 is activated.

The automatic decline feature 28 receives instructions from the managing platform 10 to tell the acquirer 32 that the authorization for the transaction is denied. Note that the authorization will only be declined, using an automatic decline feature, if the transaction is interrupted by the managing platform 10 and the managing platform 10 provides instructions to decline the transaction. If the managing platform 10 for some reason is not operating or responding, a transaction will continue to be authorized without using the cardholder parameters 22 defined in the managing platform 10. This is incorporated into the managing platform 10 to prevent the payment cardholder 12 from being denied the ability to use the payment card 14 due to technical difficulties with the managing platform 10.

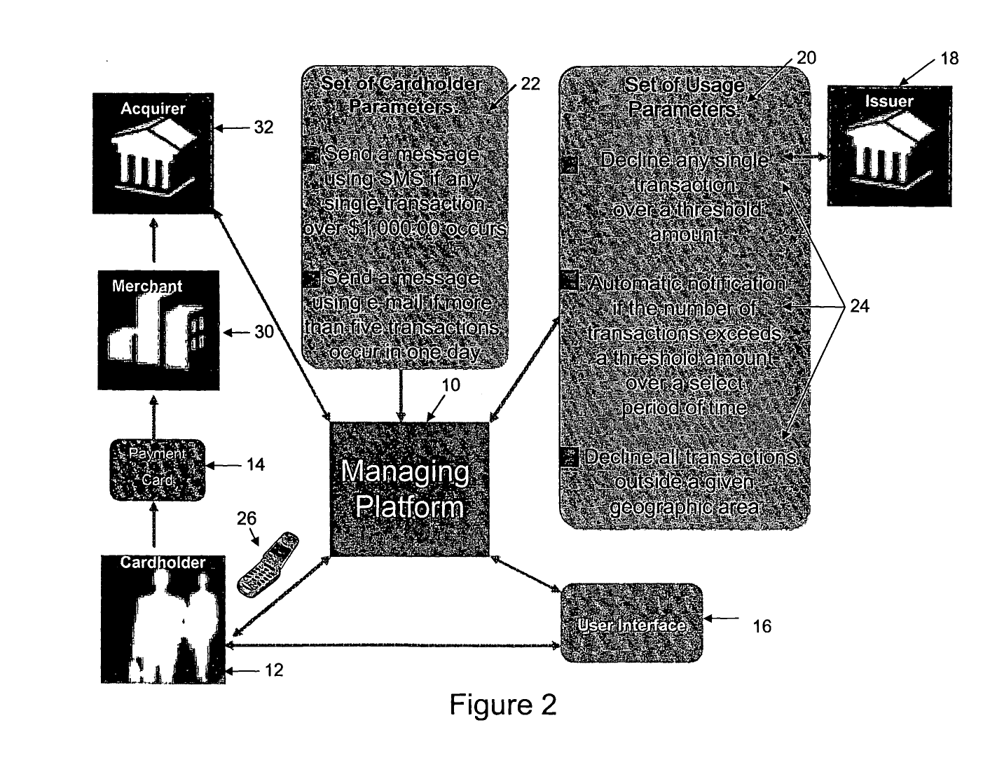

FIG. 2, further provides an example of the present invention using a managing platform 10 to allow a payment cardholder 12 to monitor spending on a payment card 14 at the time transactions are processed and after transactions are processed using the user interface 16. As indicated above, the automatic decline feature 28 is optional and the embodiment shown in FIG. 2 does not include the automatic decline feature 28 (although it could include it).

The user interface 16 may be optionally configured to permit the transactions of one or more of the payment cards 14 to be displayed. At anytime after the transaction occurs, the payment cardholder 12 may access the user interface 16 and view all the transactions that were processed using the payment cards 14. The display may be of any known type and may be linked to the managing platform 10 in any known manner, such as by wired or wireless connections.

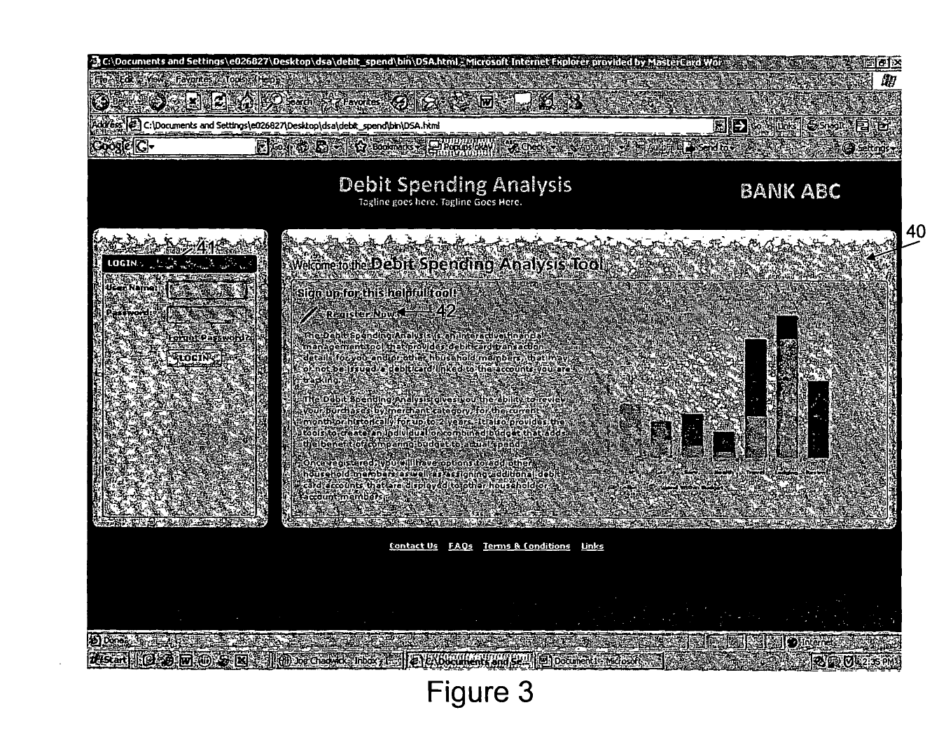

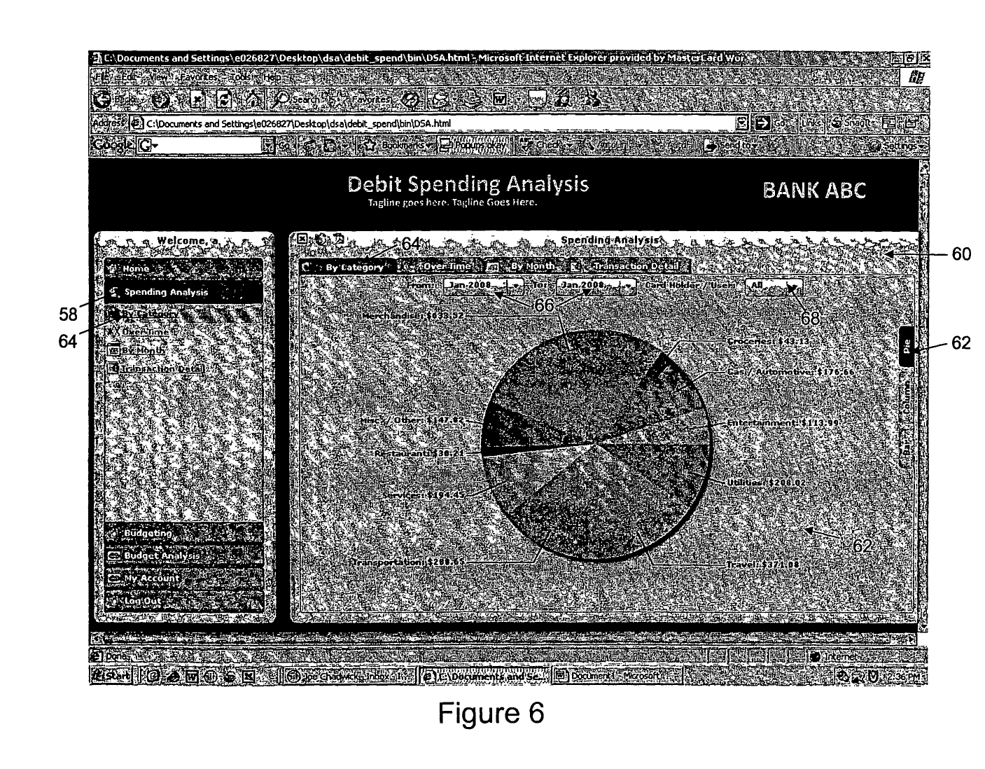

The managing platform 10 may also provide the payment cardholder 12 with an analysis of spending using the transactions that were processed on the payment cards 14. The spending analysis may show spending for one or multiple payment cards 14 and may include a list of transactions, graphs, and budgeting tools to assist the payment cardholder 12 in analyzing spending habits. FIGS. 3-14 below provide more details and examples of an exemplary configuration of the user interface 16. FIGS. 6-14 also show possible spending analysis and budgeting tools available through the managing platform 10 and accessed by the user interface 16. FIGS. 3-14 show examples of various web-pages which may be used with the present invention. As will be recognized by those skilled in the art, the user interface 16 may be of various configurations, including of different internet-based configurations or other graphical user interfaces.

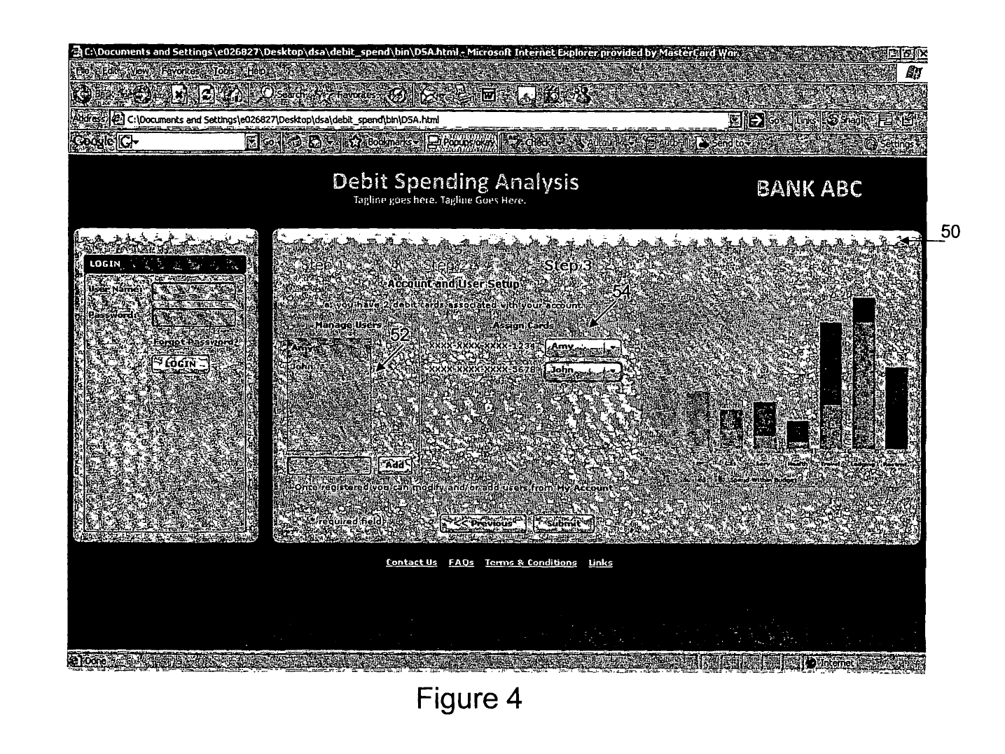

FIGS. 3-14 provide exemplary screen shots of the user interface 16 suitable for controlling and managing spending for a payment card using spending analysis and budgeting tools. With reference to FIG. 3, an introductory portal or log-in screen 40 may be provided, which allows a payment cardholder 12 to log into an account, e.g. using a password 41, or register 42 for a new account. Known log-in security measures may be utilized (e.g., password protected, secure web-site, etc.). FIG. 4, shows an account configuration screen 50. The account configuration screen 50 may enable the payment cardholder 12 to set up and manage multiple users 52 and assign 54 various quantities of the payment cards 14 to each of the payment cardholders 12.

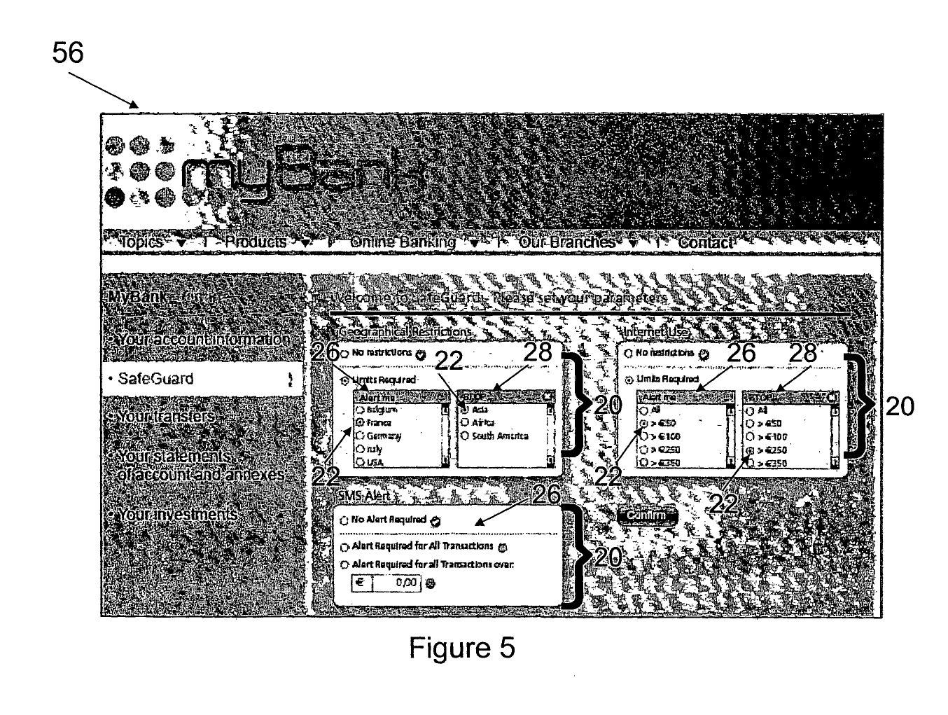

The user interface 16 may include a cardholder parameter setting screen 56, which may be provided with the spending analysis and budgeting tools or separately therefrom (e.g., in a separate secure web-site or graphical user interface). FIG. 5 provides a screen shot of an example of the parameter setting screen 56 containing the available usage parameters 20 and the cardholder parameters 22 selected and defined by the payment cardholder 12. As will be recognized by those skilled in the art, the parameter setting screen 56 may have various configurations that include a variety of options for the usage parameters 20 and the cardholder parameters 22, including, but not limited to providing the payment cardholder 12 with the ability in define cardholder parameters 22 by filling in blanks and selecting from pre-defined parameters (e.g., pull-down menus or lists). The ability to designate transactions for initiating the message 226 and/or the automatic decline feature 28 may also be provided.

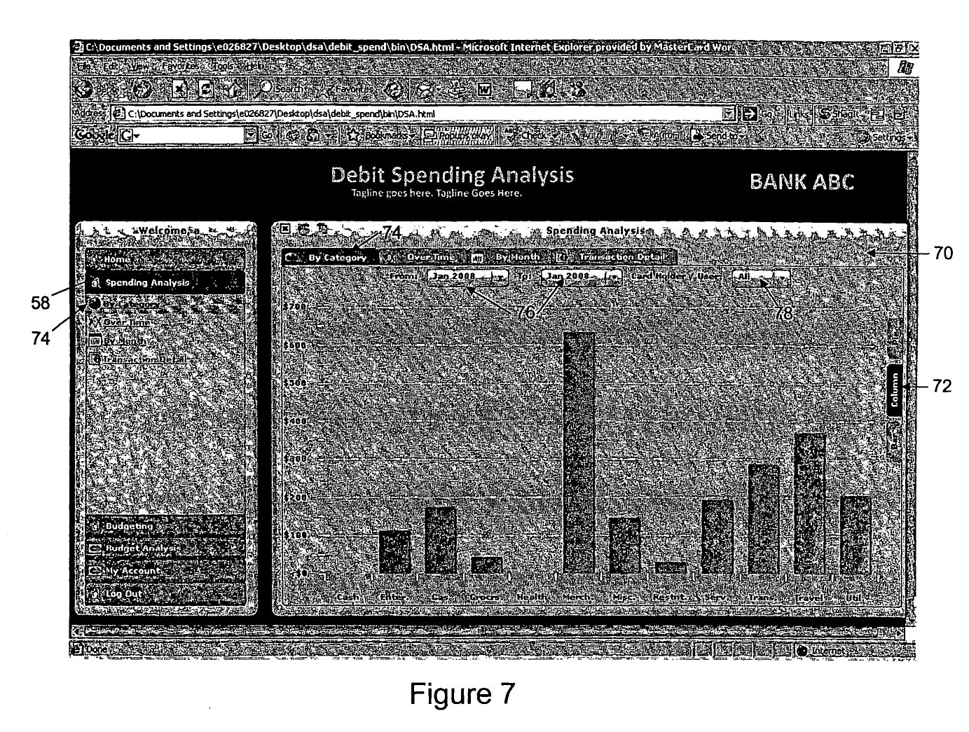

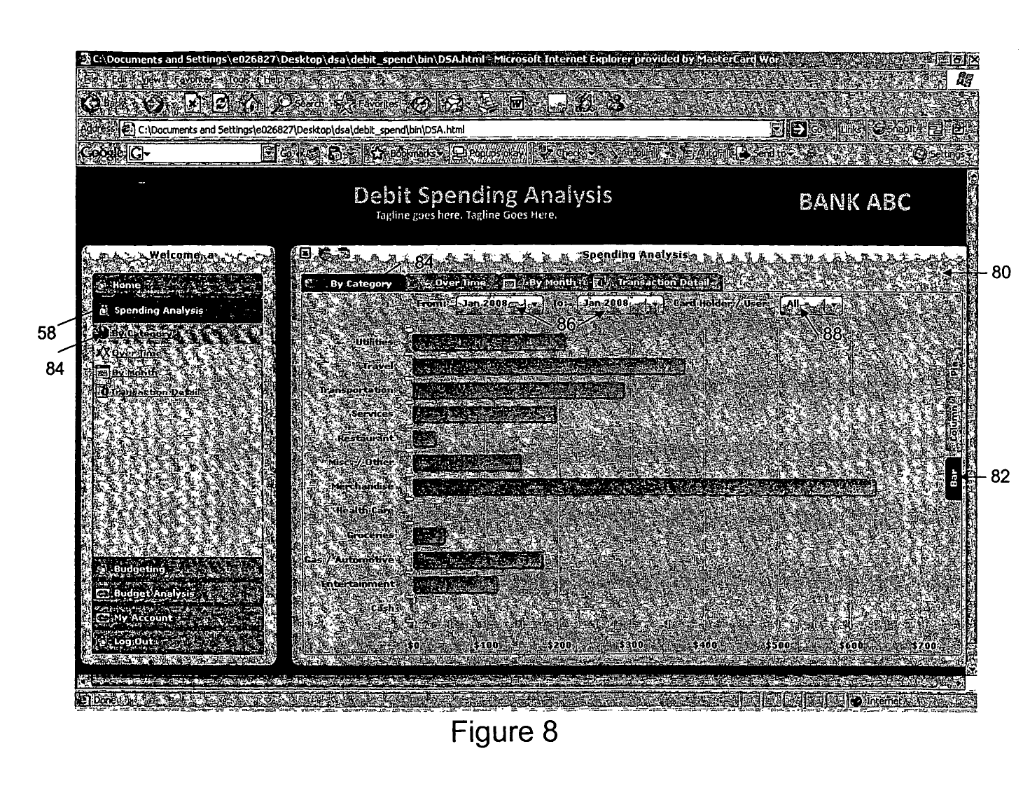

FIGS. 6-8 provide examples of various spending analysis tools 58 available with the amounts spent identified by transaction categories displayed on each screen 60, 70, and 80 of the user interface 16. A pie chart 62 is shown in FIG. 6, a column graph 72 is shown in FIG. 7, and a bar graph 82 is shown in FIG. 8. The graphical spending analysis tools are displayed by categories 64, 74, and 84 for monthly time periods 66, 76, and 86 and for the selected group of users 68, 78, and 88. The categories 64, 74, and 84 displayed may include, but are not limited to, Merchandise, Groceries, Gas/Automotive, Entertainment, Utilities, Travel, Transportation, Services, Restaurants, Cash, Healthcare, and Miscellaneous/Other.

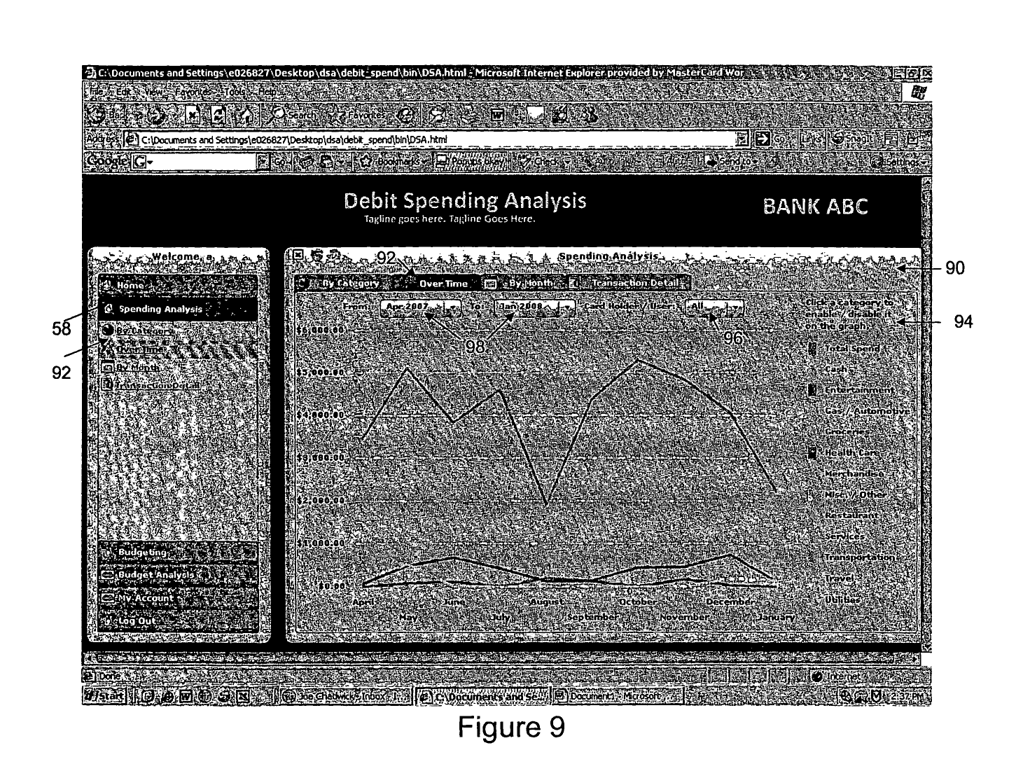

With reference to FIG. 9, a spending analysis screen 90 is shown with a graph of spending 92 for selected categories 94 and selected cardholders 96 over a selected time period of time 98. As will be recognized by those skilled in the art, the spending analysis screen 90 may have various configurations that include additional analyses of the transactions made with the payment card 14.

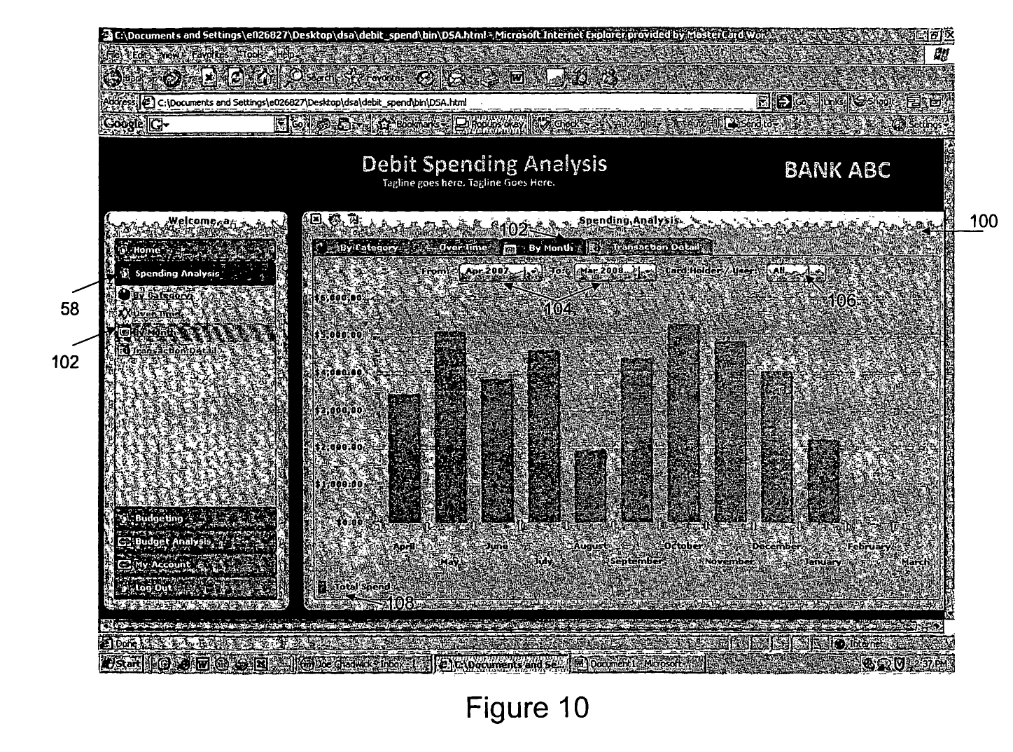

FIG. 10 shows a month by month spending analysis screen 100. Each month is represented on a column chart 102 with the months selected 104 and the cardholder selected 106. The information on the column chart 102 may include total amounts spent each month 108, amounts spent on various categories of transactions (not shown), or other variations as one skilled in the art may appreciate.

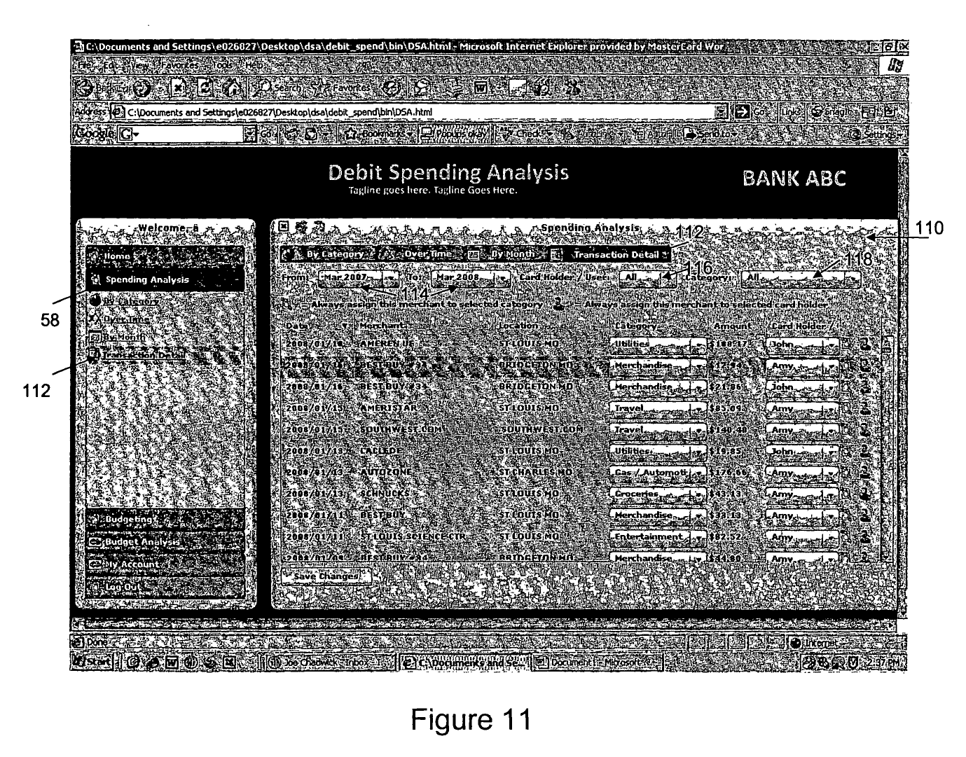

Details of all transactions 112 may be made available on a transaction detail screen 110 of the spending analysis tool 58 shown in FIG. 11. The transaction detail screen 110 may be configured to show selected dates 114, selected cardholders 116, and selected categories 118.

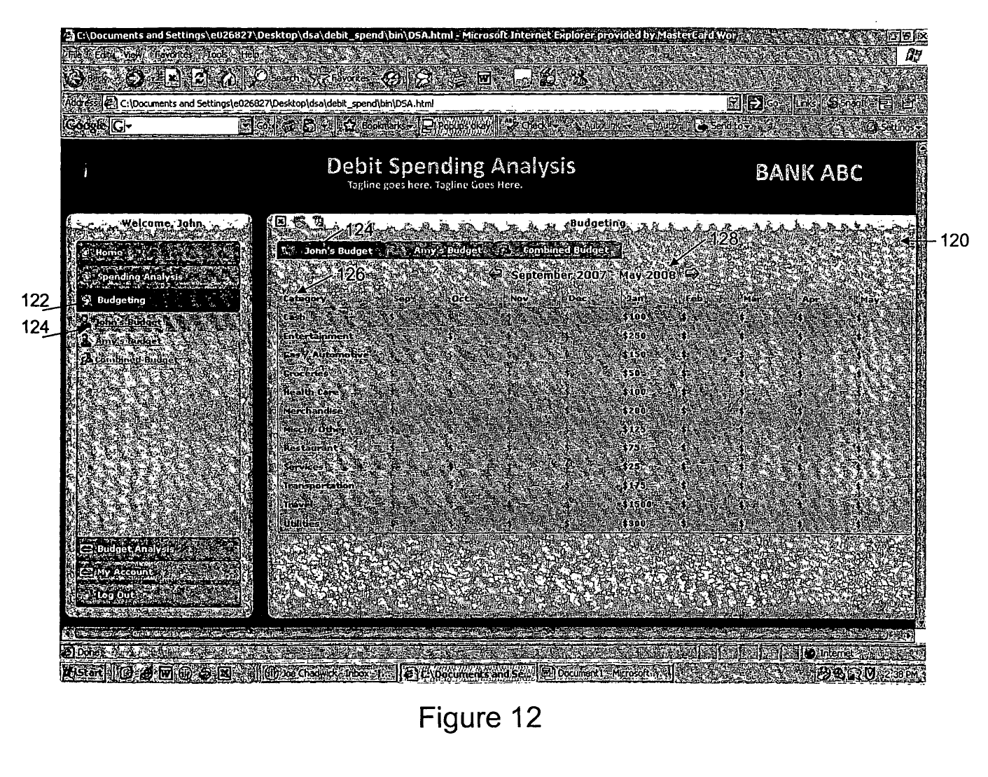

FIG. 12 provides a budgeting screen 120 with budgeting tools 122 including the ability to view each cardholder's budget, for example John's Budget 124 by category 126 and by month for the selected months 128. As will be recognized by those skilled in the art, the budgeting tools 122 may be of various configurations.

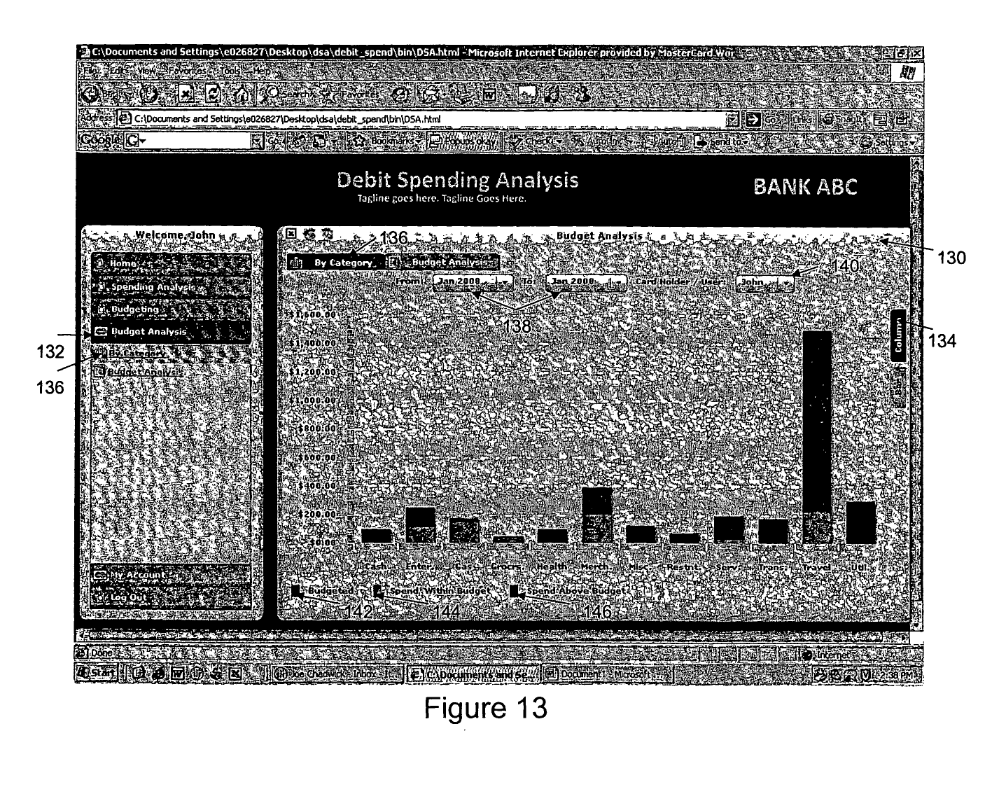

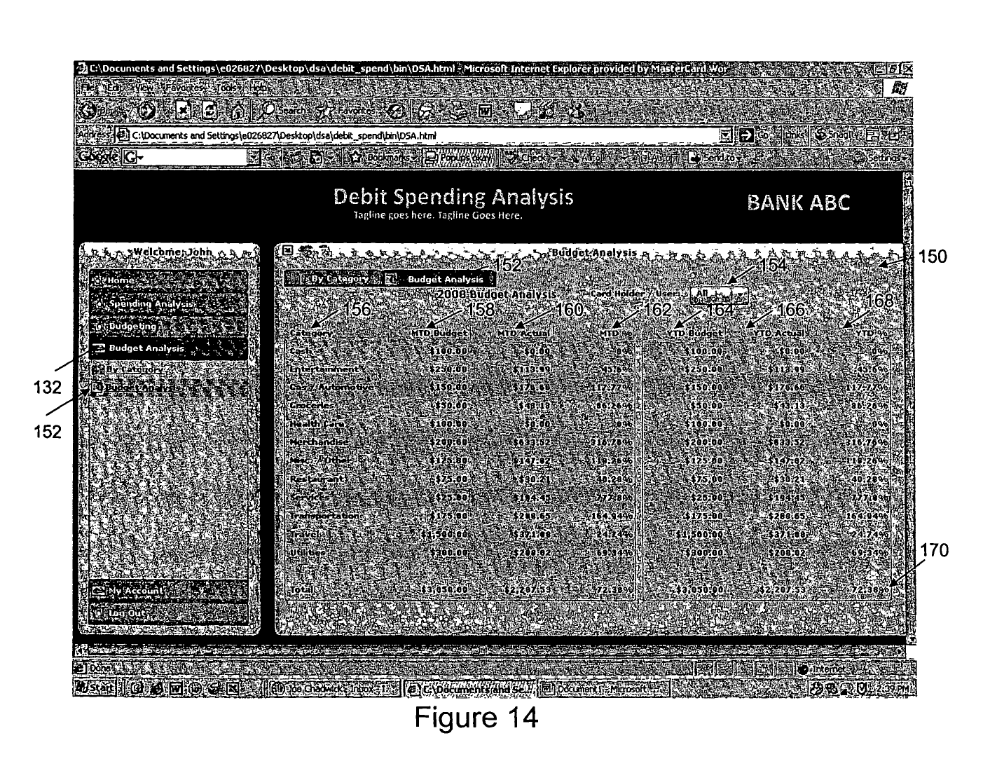

With reference to FIGS. 13-14, two budget analysis screens 130 and 150 are shown. A budget analysis tool 132 of FIG. 13 is shown as a column graph 134 or optionally a bar graph (not shown) with transaction amounts by categories 136 for a selected period of time 138 and for selected cardholders 140. The column graph 134 shown includes a column indicating the amount budgeted 142 for each category 136, the amount spent within budget 144, and the amount spent above budget 146. FIG. 14 specifically provides a budget analysis 152 that allows selection of the cardholder(s) 154 and lists the budgeted categories 156, the Month-to-Date Budget 158, the Month-to-Date Actual amount spent 160, the Month-to-Date percentage of Budget spent 162, the Year-to-Date Budget 164, the Year-to-Date Actual amount spent 166, and the Year-to-Date percentage of budget spent 168 with a total 170 for each category included on the screen. One skilled in the art will recognize that the budget analysis screens 130 and 150 may be of various configurations.

Advantages of the present invention include the payment cardholder's 14 ability to have control when using payment cards 14. The managing platform 10 advantageously allows the payment cardholder 12 to have direct influence on the authorization process. With such direct influence, the payment cardholder 12 has the ability to review the payment card 14 to ensure that the payment card 14 is operating properly and that fraud risks are being mitigated. The payment cardholders 12 may obtain confidence because the control provided by the subject invention offers fraud protection, giving the payment cardholder 12 confidence in the payment card 14, which results in a greater willingness to use the payment card 14 instead of cash.

Although preferred embodiments of the present invention have been described herein with reference to the accompanying drawing, it is to be understood that the invention is not limited to any precise embodiment and that various other changes and modifications may be affected herein by one skilled in the art without departing from the scope or spirit of the invention, and that it is intended to claim all such changes and modifications that fall within the scope of the invention.

What is claimed is:

1. A method for providing a payment cardholder with control over a payment card comprising:
configuring, through use of a managing platform, a set of usage parameters for usage of the payment card;
associating the payment card with said managing platform;
allowing the payment cardholder to select one or more of said usage parameters;
associating a set of cardholder parameters with the payment card based on said selected usage parameters, wherein said cardholder parameters include defining rules for each said selected usage parameter for determining an acceptable transaction and an unacceptable transaction for the payment card; intercepting an authorization for each transaction of the payment card by said managing platform;
identifying, based on said cardholder parameters, each said transaction as being one of said acceptable transactions or said unacceptable transactions; and
notifying the payment cardholder, using a message, of at least one said unacceptable transactions.

2. The method of claim 1, further comprising declining said authorization for said transactions identified by said cardholder parameters as said unacceptable transactions.

3. The method of claim 2, wherein declining includes obtaining verification from said managing platform prior to declining said authorization for each said unacceptable transaction.

4. The method of claim 1, wherein said set of usage parameters includes any combination of one or more characteristics selected from the group consisting of: a limit on aggregate transaction amounts over a specified time period; a limit on a single transaction amount; a maximum number of transactions in a specific time period; a maximum number of transactions for specific types of transactions; a maximum number of each specific type of transactions; a limit on geographic use of the card; a block on specific types of transactions; a limit on geographic use of the payment card based on transaction type; a limit on days of a week when a payment card may be used; and, a limit on a time of day when a payment card may be used.

5. The method of claim 1, wherein said usage parameters are configured by a payment card issuer.

6. The method of claim 1, wherein said step of allowing the payment cardholder to select one or more of said usage parameters is conducted via said managing platform.

7. The method of claim 1, wherein delivery of said message includes any combination of one or more delivery methods selected from the group consisting of: SMS, e-mail, instant messaging, real-time communication channel, and near real-time communication channels.

8. A method for providing a payment cardholder with control over a payment card comprising:
configuring, through use of a managing platform, a set of usage parameters for usage of the payment card;
associating the payment card with said managing platform;
allowing the payment cardholder to select one or more of said usage parameters;
associating a set of cardholder parameters with the payment card based on said selected usage parameters, wherein said cardholder parameters include defining rules for each said selected usage parameter for determining an acceptable transaction and an unacceptable transaction for the payment card;
intercepting an authorization for each transaction of the payment card by said managing platform;
identifying, based on said cardholder parameters, each said transaction as being one of said acceptable transactions or said unacceptable transactions; and
declining, through an automatic decline feature, at least one said authorization for said transaction identified by said cardholder parameters as one of said unacceptable transactions.

9. The method of claim 8, wherein said automatic decline feature requires verification from said managing platform prior to declining said authorization for each said transaction.

10. The method of claim 8, wherein said set of usage parameters includes any combination of one or more characteristics selected from the group consisting of: a limit on aggregate transaction amounts over a specified time period; a limit on a single transaction amount; a maximum number of transactions in a specific time period; a maximum number of transactions for specific types of transactions; a maximum number of each specific type of transactions; a limit on geographic use of the card; a block on specific types of transactions; a limit on geographic use of the payment card based on transaction type; a limit on days of a week when a payment card may be used; and, a limit on a time of day when a payment card may be used.

11. The method of claim 8, wherein said usage parameters are configured by a payment card issuer.

12. The method of claim 8, wherein said step of allowing the payment cardholder to select one or more of said usage parameters is conducted via said managing platform.

13. The method of claim 8, wherein delivery of said message includes selection based on any combination of one or more combination of delivery methods selected from the group consisting of: SMS, e-mail, instant messaging, and other real-time and near real-time communication channels.

14. A method for providing a payment cardholder with the ability to manage a payment card comprising:
configuring, through use of a managing platform, a set of usage parameters for usage of the payment card;
associating the payment card with said managing platform;
allowing the payment cardholder to select one or more of said usage parameters;
associating a set of cardholder parameters with the payment card based on said selected usage parameters, wherein said cardholder parameters include defining rules for each said selected usage parameter for determining an acceptable transaction and an unacceptable transaction for the payment card;
intercepting each transaction of the payment card by said managing platform;
identifying, based on said cardholder parameters, each said transaction as being one of said acceptable transactions or said unacceptable transactions; and
displaying information on a set of selected transactions based on a set of all transactions for the payment card, using a user interface.

15. The method of claim 14, wherein said set of usage parameters includes any combination of one or more characteristics selected from the group consisting of:
a limit on aggregate transaction amounts over a specified time period;
a limit on a single transaction amount; a maximum number of transactions in a specific time period;
a maximum number of transactions for specific types of transactions; a maximum number of each specific type of transactions;
a limit on geographic use of the card; a block on specific types of transactions; a limit on geographic use of the payment card based on transaction type;
a limit on days of a week when a payment card may be used; and,
a limit on a time of day when a payment card may be used.

16. The method of claim 14, wherein said usage parameters are configured by a payment card issuer.

17. The method of claim 14, wherein said step of allowing the payment cardholder to select one or more of said usage parameters is conducted via said managing platform.

18. The method of claim 14, wherein said user interface provides an analysis of said selected transactions.

19. The method of claim 18, wherein said analysis is based on any combination of one or more combination of characteristics selected from the group consisting of: a transaction category, a specified time period, a specified payment card, a set of details for the transaction, and a comparison of transaction amounts and budgeted transaction amounts.

20. The method of claim 14, wherein said user interface provides a graphical display of said selected transactions.

21. The method of claim 20, wherein said display may be selected from the group consisting of: a bar graph, a column graph, a pie graph, a line graph, a list, and combinations thereof.
